(19) United States
(12) Patent Application Publication
(10) Pub. No.: US 2003/0222760 A1
(43) Pub. Date: Dec. 4, 2003

(54) Locker system

(76) Inventor: Kouichiro Hara, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/154,782

(22) Filed: May 28, 2002

(51) Int. Cl. G05B 19/00

(52) U.S. Cl. 340/5.73

(57) ABSTRACT

A locker system having a locker space booking function, said locker system comprising a locker 4 including locker boxes allowing lock/unlock operations by means of electric signals; and a managing center 5 connected to said locker by way of a first line 8, said managing center being further connected to a second line 2 so as to allow search for vacancy information of said locker box and request for reservation of said locker box in case vacancy information of said locker is obtained from a client terminal by way of the second line.

### BACKGROUND OF THE INVENTION

1. Field of the Invention

The present invention relates to a locker system which is designed to deliver goods purchased on the Internet, or over the counter at shops or department stores to delivery lockers installed at nearest railway stations, convenience stores or public facilities such as post offices in accordance with the designation by the purchaser.

2. Description of the Prior Art

Nowadays, the home delivery locker system is installed at a collective housing such as condominiums such that the recipient may be able to receive purchased goods even if he or she is not home at the time of delivery. Said home delivery locker system allows the delivery and pickup procedure in such a manner that a home delivery personnel can deposit a parcel of the goods addressed to a condominium dweller into a locker box of said locker system and puts a receipt of the parcel into a mail box of the recipient dweller such that the dweller finding the receipt in the mail box may produce and insert his or her card into a card reader of the home delivery locker for authentication. Installment of such home delivery locker is of utmost help both to home delivery agents and dwellers in the condominium.

It is to be noted that although such system is suited to the collective housing but not to a small apartment house or an ordinary house because the home delivery locker is too expensive actually to be installed for such purpose. To cope with the situation, a system allowing the pickup of purchased goods at a JR (Japan Railways) station kiosk or a convenience store if the goods are purchased on the electronic commerce on the Internet. Such system further allows the settlement of the purchase price of the goods in addition to the pickup thereof on the purchaser's way back home from work.

There is, however, a problem that such kiosks at rail way stations are closed too early for purchasers of the goods who usually come home late. On the other hand, the convenience stores which are open around-the-clock are useful for nighttime pickup but if such convenience store is located far from the dweller's nearest station, he or she is required to take a roundabout course for pickup. Furthermore, said system is not useful for people living in a less populated area far away from the railway station because the convenience store is only located in a densely populated area.

### SUMMARY OF THE INVENTION

The present invention is aimed at solving the above discussed problems and its object is to provide a locker system capable of reserving a locker box which is being unused on the day and time of the purchaser's designation done at the time of buying the goods to secure the space for deposit of the goods. This is done by installing lockers, especially in railway stations under the control of the managing center to secure vacancy information on locker boxes of said delivery locker installed in various sites. In order to realize the above object, there is essentially provided a locker system having a locker space booking function, said locker system comprising a locker including locker boxes performing lock/unlock operations in response to electric signals; and a managing center connected to said locker by way of a first line, said managing center being further connected to a second line so as to allow search for vacancy information of said locker box and request for reservation of said locker box by way of the second line in case vacancy information is available.

In the present invention, it is preferable that said locker space booking function includes sending of signals to lock at least one of said locker boxes by way of said first line.

It is further preferable that said second line is connected to an electronic commerce transaction system, said request for reservation of said locker including at least information concerning a delivery place of a purchase.

It is still further preferable that said managing center has a function to transmit an acknowledgement of the request for reservation to a customer by way of said second line if said reservation of the locker box is successful.

It is still further preferable that said managing center has a function to transmit a request for delivery together with information concerning the place of delivery to a delivery agent by way of said second line.

It is still further preferable that said locker has a deposit sensing function to detect a deposit of a parcel thereinto, said delivery sensing function including transmitting upon delivery of the parcel at least information thereabout to said managing center, said managing center being adapted to transmit information about completion of deposit to said customer by way of the second line.

It is still further preferable that said managing center has a function to form a pass word for unlock the reserved locker box, said pass word being stored in correspondence with a location of said reserved box, said acknowledgement of request and information about completion of delivery containing said pass word.

It is still further preferable that said locker has a function to store the pass word transmitted thereto by way of the first line in stead of being stored in said managing center.

It is still further preferable that said locker has a function to receive entry of said pass word, said pass word being compared with a pass word stored in the managing center or the locker and to unlock the locker box if there is coincidence of the pass words.

It is still further preferable that said managing center has a function to register and store membership information, said locker having a card reader such that card settlements are made by way of said card reader.

### BRIEF EXPLANATION OF THE DRAWINGS

FIG. 1 is a block diagram showing the outline of the system for commercial transactions by use of delivery lockers according to the present invention;

FIG. 2 is a flow chart showing the locker box reservation procedure;

FIG. 3 is another flow chart showing the goods depositing procedure succeeding to the procedure shown in FIG. 2; and

FIG. 4 is a further flow chart showing the goods pickup procedure from the locker.

### DETAILED DESCRIPTION OF PREFERRED EMBODIMENTS

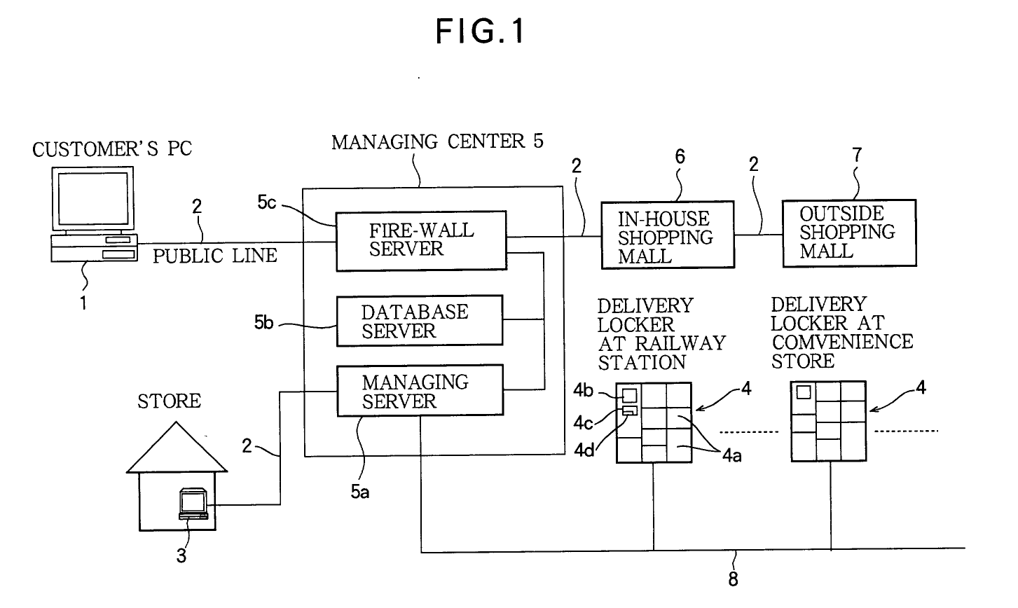

The locker system according to the present invention will be explained referring to the attached drawings. In FIG. 1 which is a block diagram showing the structure in general, the numeral 1 denotes a computer of the customer. The numeral 2 denotes a second line to connect said computer 1 and shopping malls 6 and 7 by way of a fire wall server 5c of a managing center 5, which will be explained later. The numeral 3 denotes a point-of-sale terminal as used in department stores or retail shops to be connected to the managing server 5a of the managing center 5 by way of said second line 2. The numeral 4 denotes delivery lockers installed at the public facilities such as railway stations, convenience stores, post offices or the like.

Each delivery locker 4 is composed of a plurality of locker boxes 4a; ten keys (not shown) for opening said locker boxes 4a; card readers 4b for reading the house cards issued by the managing center 5, credit cards, ic cards, debit cards or the like; liquid crystal displays 4c to indicate messages to customers, operation procedures or the like; a printer 4d to issue a receipt when the home delivery personnel deposits a parcel in the locker box 4a or when the customer picks up the parcel or makes a card settlement; sensor means for determine whether the parcel is in a locker box 4a and sensor means for detecting open/close operations of a door of the locker box.

The managing center 5 has three servers 5a through 5c; said server 5a being a managing server connected to each delivery locker 4 installed in a railway station as mentioned above, by the public line, a first line 8 of optical fibers; said server 5b being a data server having accumulated data about members registered in advance therein; and the server 5c being a fire wall server connected to said computer 1 of the user by way of said second line 2 to prevent any sabotage or pilferage of data in the managing server 5a and the data server 5b.

Said managing server 5a keeps vacancy information of the locker boxes 4a of all the delivery lockers 4 under the control thereof such that if a customer doing some shopping at an in-house shopping mall 6 and an outside shopping mall 7 which the managing center opens on the Internet wishes to have vacancy information of a certain delivery locker located at a destination, said vacancy information is disclosed on the net while if a customer purchases goods over the counter at an ordinary store, the disclosed vacancy information is obtained on a point-of-sale terminal 3 installed at said store by accessing the managing server by way of the public line to know vacancy information of a locker box 4a of his or her choice.

It is to be noted here that the vacancy information of delivery lockers 4 can be obtained by an output from a parcel detecting sensor installed in said locker box 4a. Since various sizes of locker boxes are provided to receive parcels of large, medium or small sizes, it is required to control the vacancy information in correspondence with information related to the size of the locker box 4a.

Said data base server 5b functions to store and administer membership information, pass words allotted to the members by the managing center and card information on house cards, credit cards, IC cards and debit cards that the members use. Said data base server 5b determines whether or not an opening operation of a locker door is done by a legitimate member when a pass word is entered by way of ten keys to open the door of a delivery locker box 4a or inserts a house card or the like into the card reader and further determines whether or not the settlement of the purchase price at the delivery locker is performed by a legitimate member. It is to be noted that the managing center 5 has a function to store the pass word in correspondence with the position of the destination locker box 4a.

The in-house shopping mall 6 is operated by the managing center 5 which allows access by a customer by way of the managing center 5. The outside shopping mall 7 is operated by another company under contracts concluded with the managing center 5 and is configured so as to allow access by way of the shopping mall 6. Thus, when shopping is done at the shopping mall 7, the shoppers there are allowed to readily use information on the managing server 5a of the managing center 5 and the data base server 5b.

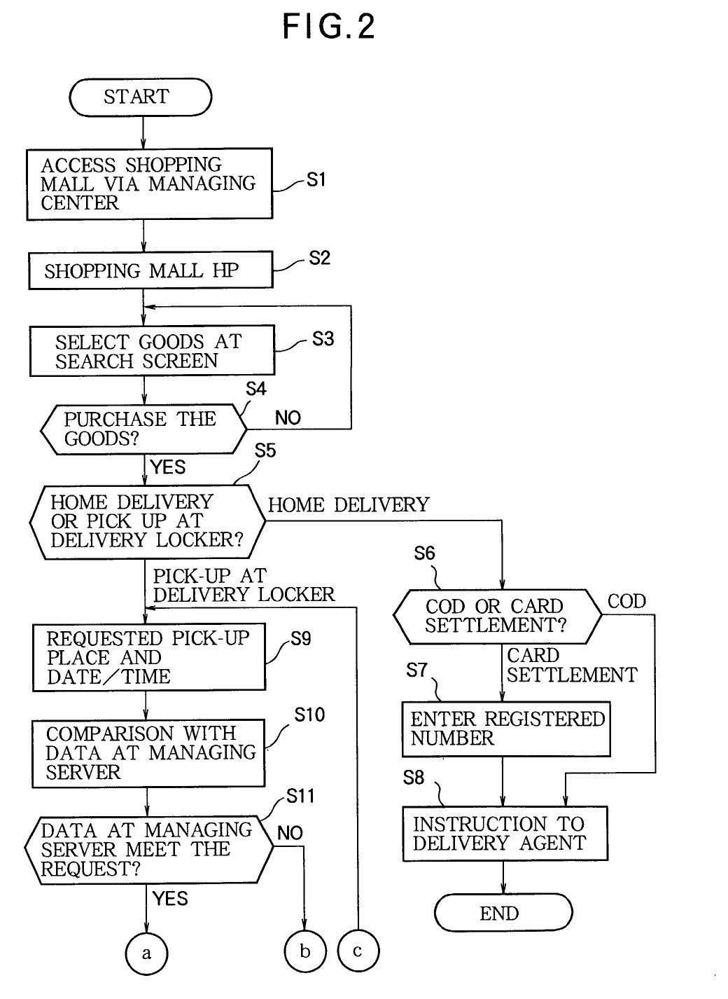

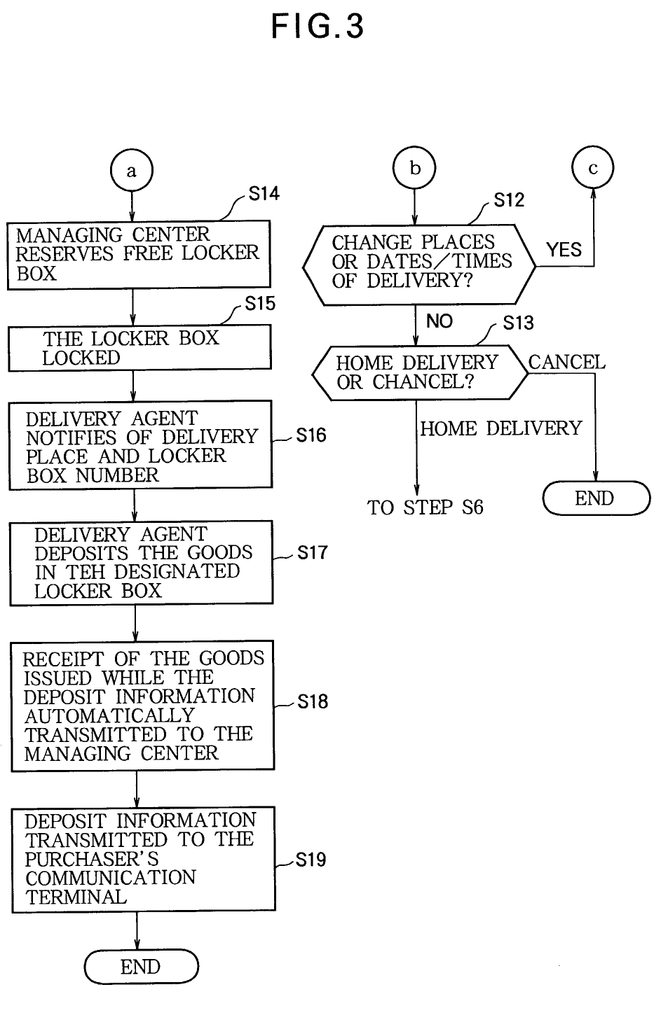

Next, the procedures followed in the system starting from purchasing of goods at the shopping mall 6 or 7 by way of the second line 2 until depositing of the purchased goods in a delivery locker 4 installed at a railway station designated by the shopper will be explained with reference to FIG. 2 and FIG. 3.

It is to be noted that candidate users of the delivery locker 4 are required to register their membership at the managing center. Credit cards, IC cards or debit cards may be registered for such purpose. Otherwise, pass words may be allotted to the candidate users or house cards may be issued to them.

First, the customer who wishes to purchase goods using the second line 2 can access the HP (home page) of the in-house shopping mall 6 opened by said managing center 5 from his or her own computer at home by way of the computer of the managing center (Step S1).

When the HP of the shopping mall 6 is accessed, the screen showing the shopping mall 6 appears on the display of the shopper's computer 1. (Step S2). It is to be noted that if the outside shopping mall 7 is to be accessed, characters indicating the HP of said shopping mall 7 appearing the screen of the shopping mall 6 may be clicked on.

Then, the goods of his or her choice are searched for at the search screen (Step S3). Under the situation, the computer of the managing center 5 monitors to see whether or not a command to purchase the goods (Step S4) is issued. If the goods to be purchased is decided on, the display of the customer's computer indicates options as to whether home delivery or pick up locker 4 appears such that the customer selects either of said options. (Step S5).

If the home delivery is selected, further options as to whether the purchase price is to be collected on the COD (cash on delivery) basis or the settlement by card to be done appear on the screen. (Step S6) If the card settlement is to selected, the card number of the credit card or the like registered at the managing center 5 is entered. If the purchase price collect is selected, on the other hand, the purchase price collect is designated (Step S7). When the foregoing procedure completes, the managing center 5 issues the shipping instruction to the home delivery agent by way of the dealer joining the shopping mall 6 or 7 (Step S8). It is to be noted that in the event of payment on the COD basis, the settlement is performed upon delivery of the goods to the purchaser's home (payment in cash to the home delivery agent or bank transfer later).

In the event that the pickup of the goods at the delivery locker 4 installed in the railway station is selected at Step S5, information concerning the request for use of the locker 4 including a specific name of the railway station and the date/time of delivery are designated by way of the first line 8 (Step S9). It is to be noted that the names of the railway station to be designated by the customer are designed to be easily obtained because the name of the designated railway station in which the delivery lockers are installed are designed to appear on the screen for the respective railway lines, the areas or the like.

When the name of a railway station and the time and date are designated on the screen at said Step S9, said designated items are transferred to the managing server 5a of the managing center 5, where comparison is made with vacancy information stored in advance in the managing server 5a (Step S10) to represent the result thereof on the display (Step S11). If the selected place and the time/date fail to correspond to the vacancy information, in other words, if there is no vacancy information available with regard to the selected place, the display shows a message on the screen to announce that there is no open locker box available, asking as to whether or not to change places and dates of delivery. (Step S12)

Here, if the customer is prepared to accept a change in places or dates of pickup, he or she can return to the Step S9 to receive information concerning a free locker box 4a and follow similar instruction thereof. If he or she does not wish to change the place and time/day of pickup at the Step S12, the display screen shows a message at the Step 13 which asks questions as to whether or not he or she wishes for home delivery and whether or not he or she wishes to cancel the purchase of the goods. If the canceling is instructed, all the operations is terminated. On the other hand, if he or she enters an instruction for home delivery, the operation returns to the Step S6 before terminating the procedure.

If the locker box 4a of the customer's choice is judged to be open at the Step S11, the managing center 5 issues an instruction in the form of a signal to the effect that said open locker box 4a be reserved by way of the first line such that any other customer will not use said locker box. (Step S14). The pickup locker 4 which received said instruction locks said reserved locker box 4a (Step S15).

Further, the managing center 5 issues an instruction to a dealer opening a store on the shopping malls 6 and 7 by way of the second line 2 to the goods be dispatched while notifying the dealer of the name of the railway station and the number of the locker box (Step S16). Then, a delivery agent entrusted by said dealer goes to the delivery locker 4 at the designated railway station to insert a card issued by the managing center 5 into the card reader and enter a locker box number such that the related locker box 4a in unlocked to open such that the deposit of the parcel of the goods thereinto is allowed. (Step S17).

Once the goods is deposited in said locker box 4a, a sensor (not shown) equipped in said locker box 4a for detecting the presence or absence of the goods issues signals representative of the result of detection of the goods to the managing center 5 by way of the first line 8 while a receipt of he goods is issued. (Step S18). The managing center 5 receiving such goods deposit signal issues an acknowledgement of the request for reservation in the form of a notice of the deposit of the goods in the designated locker box 4a by way of the second line 2 to communication terminals (for example, telephone sets including cellular phones, fax machines, e mail terminals, or the like) decided upon with the members or customers (Step S19). Therefore, the customer receiving this notice can go to the locker box 4a for pick-up of the goods. It is to be noted that said acknowledgement of the request for reservation contains the pass word formed by the managing center, said pass word being stored at the managing center in correspondence with the location of the locker box 4a.

It is to be noted that the previous embodiment concerns an example of electronic commerce. If shopping was done over the counter at department stores or the like, the shopper hands the goods he or she has purchased to a store employee requesting to deliver the same to the delivery locker 4. Then, the store employee connects the point-of-sale terminal 3 at said store to the managing server 5a of the managing center 5 to investigate whether o0r not there is any open locker box 4a at a railway station at a time on a day that the customer designates. If there is an open locker box, a command to reserve said open locker box 4a by way of the managing center 5 while a depositing procedure into the locker box 4a by way of a delivery agent or the like starts to be taken. This depositing procedure and operations subsequent thereto are to be omitted because they are similar to those done after the Step S16 as already explained.

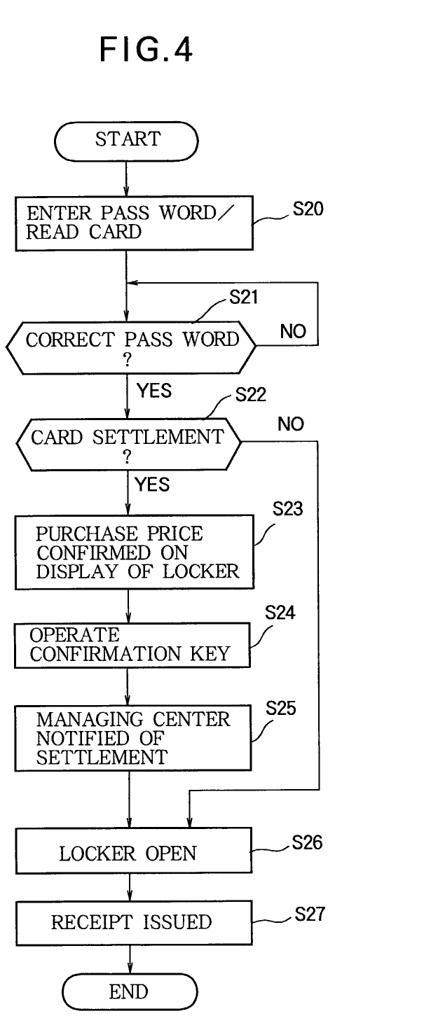

Next, the system for the customer to take out the goods from the locker box 4a will be explained with reference to the flow chart in FIG. 4.

The customer who received a notice of deposit through said Step S19 goes to the designated delivery locker 4a and enters a pass word formed by the managing center 5 by means of ten keys of the used delivery locker 4. Alternatively, a house card allocated by the managing center 5 or another type of card recorded in advance at the managing center 5 is inserted into the card reader 4c such that the pass word or the card number is transmitted to the managing center 5 from the delivery locker 4 (Step S20).

The data base server 5b of the managing center 5 which received said pass word or the card number determines whether or not the entered pass word or the card number is correct and if not correct, a further entering is prompted. (Step S21) If it is judged that the entered pass word or the entered card number is correct, a judgment is made as to whether or not the settlement of the purchase price of the goods is designated to be made by card (Step S22). If it is judged that the settlement by card is designated, the purchase price is shown on the display 4b of the delivery locker 4 (Step S23).

Then, the purchaser confirms the amount shown on the display 4b and operates the confirmation keys installed at the delivery locker 4 (Step S24) and then, a notice is given at the managing center 5 to the effect that the card settlement has been performed. (Step 25). Then, the managing center 5 collects the amount to be settled on behalf of the card company and attends to the payment to the card company.

Further, if said pass word is entered, the amount equivalent to that on the display is entered by ten keys such that the settlement is notified to the managing center 5. The managing center 5 issues a notice of payment to the customer and collects said amount of money to pay the same to the shipping party of the goods to complete the settlement.

If said settlement have been completed or is over, a signal to unlock the locker box 4a is issued directly to the delivery locker 4 from the managing center 5 such that the door of the locker box 4a is opened for allowing the goods to be taken out. (Step S26) Further, a receipt bearing the statement that the opening of the door and the settlement are done simultaneously is printed out from the printer 4d (Step S27) to completes the entire system operation.

It is to be noted that all the customers are members of the managing center 5 in the above embodiment. If a shopper other than the members does the shopping at the shopping malls 6 and 7 on the Internet or over the counter at ordinary stores wants to have the purchased good delivered to the delivery locker 4 installed at a railway stations and wish to take out the goods there, a pass word (for ensuring further security, said pass words being composed of the inherent pass word given and the purchase price are more effective) is issued to the shopper at the shopping mall or the store at the time of shopping. Alternatively, shoppers may have such pass words issued from the managing center 5 at the time of notifying the shoppers of the deposit of the goods into the locker box 4a such that the pass word is entered through the ten keys for pick up of the goods.

While the pick up of the goods a customer purchased has been explained with respect to the previous embodiment, the invention is applicable to such a case where a customer places an order for cleaning or photographic developing services with a laundry or photographic agent, who picks up and returns the entrusted item from and back to the locker after the job is done. In this case, the locker box 4a to which the agent returns the entrusted item may be one of the lockers located at another railway station so designated by the customer.

While the previous embodiment explains the case in which the managing center forms a pass word for unlocking the reserved locker box 4a for the customer to enter the same for a comparison step at the managing center 5, it is also acceptable that the pass word formed by the managing center 5 is stored in the pickup locker where the pass word entered by the customer to unlock the locker box 4a is compared with said pass word stored in advance therein.

Further, while the previous embodiment explains the case in which the order was placed on the Internet or over the counter at an ordinary store, the mode of order may be by telephone (the managing center may be installed with an automatic call answering device) or by fax (text recognition device may be installed).

As discussed in the foregoing, vacancy information of a number of delivery lockers installed at public places such as railway stations, convenience stores, post offices is managed at the managing center such that when a shopper who purchased goods on electronic transaction or over the counter at a store wishes to have his or her purchase delivered to a certain place on a certain date at a certain time and if the managing center has vacancy information at a certain locker at said certain place on said certain date, said vacant locker box is reserved to prevent use by another person. Therefore, no matter how many people wish to use a specific locker box, it is possible to make judgment readily as to whether said specific locker box is free and available, thus preventing such an complaint from the customer as to the effect that the purchased goods has not been delivered to the locker box.

Furthermore, as the purchaser can have his or her purchase delivered to the delivery locker box of his or her choice on his or her way to or from work, the system is so convenient to married couples working together or spinsters and information that the purchased goods are delivered to the locker is conveyed to the customer by way of a communications terminal to facilitate his or her pickup of the goods in accordance with secure delivery information.

Furthermore, as the door of the locker box is opened by entering his or her pass word or through a read-out operation using a card reader for pickup of the goods, safe and secure pickup is performed around the clock in an unattended manner. Moreover, as his or her credit card number is registered in advance at the managing center, safe transaction settlement with respect to the purchase of the goods is advantageously ensured.

What is claimed is:

1. A locker system having a locker space booking function, said locker system comprising
a locker including locker boxes performing lock/unlock operations in response to electric signals; and
a managing center connected to said locker by way of a first line, said managing center being further connected to a second line so as to allow search for vacancy information of said locker box and request for reservation of said locker box by way of the second line in case vacancy information is available.

2. A locker system according to claim 1, wherein said locker space booking function includes sending of signals to lock at least one of said locker boxes by way of said first line.

3. A locker system according to claim 2, wherein said second line is connected to an electronic commerce transaction system, said request for reservation of said locker including at least information concerning a delivery place of a purchase.

4. A locker system according to any one of claims 3, wherein said managing center has a function to transmit an acknowledgement of the request for reservation to a customer by way of said second line if said reservation of the locker box is successful.

5. A locker system according to any one of claims 4, wherein said managing center has a function to transmit a request for delivery together with information concerning the place of delivery to a delivery agent by way of said second line.

6. A locker system according to any one of claim 5, wherein said locker has a deposit sensing function to detect a deposit of a parcel thereinto, said delivery sensing function including transmitting upon delivery of the parcel at least information thereabout to said managing center, said managing center being adapted to transmit information about completion of deposit to said customer by way of the second line.

7. A locker system according to any one of claim 6, wherein said managing center has a function to form a pass word for unlock the reserved locker box, said pass word being stored in correspondence with a location of said reserved box, said acknowledgement of request and information about completion of delivery containing said pass word.

8. A locker system according to any one of claims 7, wherein said locker has a function to store the pass word transmitted thereto by way of the first line in stead of being stored in said managing center.

9. A locker system according to claim 8, wherein said locker has a function to receive entry of said pass word, said pass word being compared with a pass word stored in the managing center or the locker and to unlock the locker box if there is coincidence of the pass words.

10. A locker system according to claim 9, wherein said managing center has a function to register and store membership information, said locker having a card reader such that card settlements are made by way of said card reader.
